(19) United States
(12) Patent Application Publication
(10) Pub. No.: US 2012/0102384 A1
(43) Pub. Date: Apr. 26, 2012

(54) PRODUCT INFORMATION MANAGEMENT AND AUTOMATION

(75) Inventors: Tam Dao, San Marcos, CA (US); Robert Cowie, Escondido, CA (US); Tom Lam, Chula Vista, CA (US); Don Nguyen, San Marcos, CA (US); Guoxuan Zhang, San Diego, CA (US)

(73) Assignee: SONY CORPORATION

(21) Appl. No.: 12/912,021

(22) Filed: Oct. 26, 2010

(51) Int. Cl. G06F 3/048; G06F 17/20

(52) U.S. Cl. 715/205; 715/764; 715/705

(57) ABSTRACT

A series of UIs is presented on a computer display to allow a user to select one or more sources of help for various aspects of the computer. The user can select to have presented hyperlinks to obtain help information from the manufacturer of the computer, from the O.S. provider, and from third party providers of applications executable by the computer.

### I. FIELD OF THE INVENTION

The present invention relates generally to product information management and automation.

### II. BACKGROUND OF THE INVENTION

Computer users desiring help or instructions do not lack for resources to support their quest for information about the functions their computers can perform and what the user must do to invoke and successfully execute those functions. The problem is not the dearth of information but the abundance of it from multiple sources, which complicates the user's inquiry. For example, the manufacturer of a computer may provide help files that are loaded onto the computer; the manufacturer of the operating system of the computer likewise may provide help information related to the O.S.; and various third parties may provide help information related to software applications the computer might execute. As well, help documentation apart from the above may exist for particular computer models in various places on the Internet.

### SUMMARY OF THE INVENTION

Accordingly, a computer includes a processor and a display controlled by the processor to present a first user interface (UI) on the display. The first UI includes a first selector element selectable by a user by means of an input device communicating with the processor to select help information from a manufacturer of the computer. Also, a second selector element may be invoked to select help from an operating system (O.S.) provider associated with an O.S. executed by the processor, and help from third party application providers may be obtained by selecting a third selector element on the UI.

In some embodiments help information from the manufacturer may be preloaded onto a computer storage medium of the computer while other help information from the manufacturer is downloaded from the Internet. If desired, the UI can further include a list of help sources from which a user may select a source. The list may include a hard disk drive (HDD) of the computer, a website associated with the manufacturer of the computer, an online help forum associated with the computer type, and an Internet site associated with the provider of the O.S.

In non-limiting examples the UI further includes a list of help documentation type which includes a user guide, O.S. help guide, third party help guide, and tutorials. A second UI may be presented on the display responsive to a user request for help entered by means of the first UI, with the second UI containing hyperlinks to plural help sources. The help sources having hyperlinks in the second UI can include, e.g., specification documentation for the computer, information related to a peripheral component associated with the computer, information related to at least one software application executable by the processor, and information provider by the O.S. provider. Still further, a third UI can include hyperlinks to electronic user guides related to the model of the computer, hyperlinks to information related to devices made by the manufacturer of the computer, and hyperlinks to information related to third party software loaded onto the computer.

In another aspect, a method includes providing a series of user interfaces (UIs) on a computer display and by means of the UIs, allowing a user to select sources of help for various aspects of the computer. The sources can include the manufacturer of the computer, a provider of an operating system (O.S.) executed by the computer, and third party providers of applications executable by the computer.

In another aspect, an apparatus includes a processor and a display controlled by the processor to present a first user interface (UI) to search for multiple technical help sources by source type and a second UI providing hyperlinks to specific technical help sources conforming to a search signal entered by means of the first UI.

### BRIEF DESCRIPTION OF THE DRAWINGS

FIG. 1 is a block diagram of an example system in accordance with present principles;

FIG. 2 is a flow chart presenting logic in accordance with present principles; and

FIGS. 3-6 are user interfaces (UI) that, may be presented on the computer display to effect present principles.

### DETAILED DESCRIPTION OF THE PREFERRED EMBODIMENT

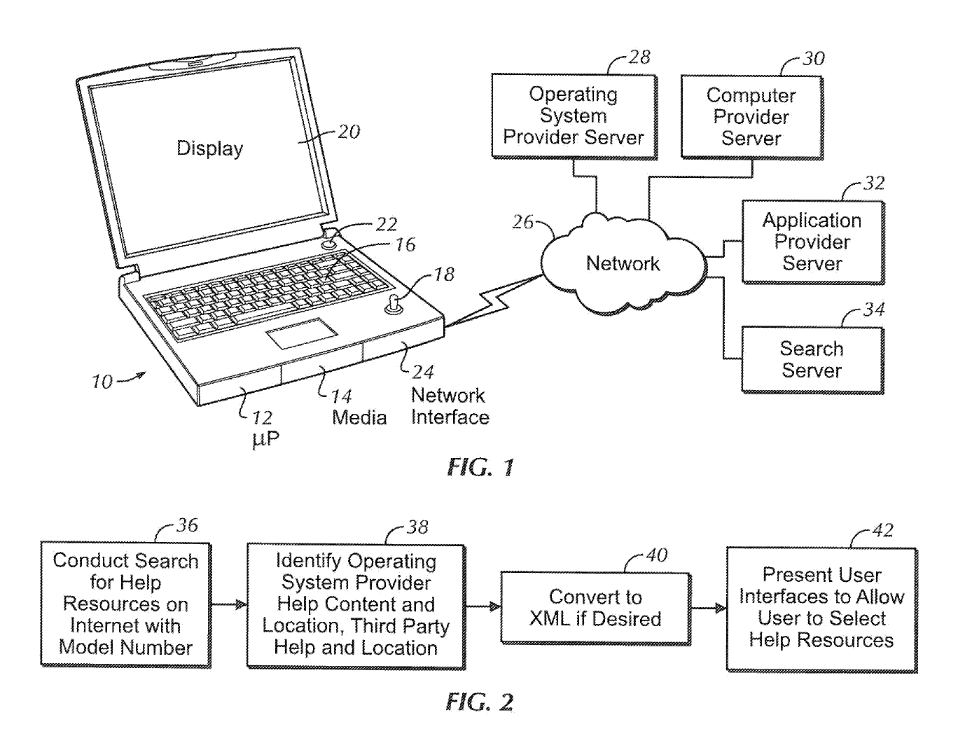

Initially referring to FIG. 1, a computer 10 such as but not limited to laptop or notebook computer includes a processor 12 accessing one or more computer readable storage media 14 such as disk-based and/or solid state storage to execute present logic. The processor 12 typically receives user input signals from input devices such as a keypad 16 and point and click device 18 and presents information including the below-described UIs on a video display 20, which may be supported on a panel that is hingedly connected to the panel supporting the keypad 16 as shown. A video camera 22 may also communicate signals to the processor 12 and may be mounted on the computer 10 as shown or may be provided as a separate device and connected to the processor 12 by, e.g., a universal serial bus (USB) connection.

The processor 12 may access one or more wired or wireless network interfaces 24 such as a Bluetooth transceiver, WiMax or WiFi transceiver, wireless telephony transceiver, wired modem, etc. to communicate with computer-implemented servers via the Internet 26. As shown, among the servers with which the computer 10 may communicate are an operating system (O.S.) provider server 28 that is affiliated with the provider of the O.S. executed by the processor 12, a computer provider server 30 that is affiliated with the manufacturer of the computer 10, and a third party application server 32 that is affiliated with third party providers of software applications executable by the processor 12. Also, a search server 34 may communicate with the computer 10 and the other servers for executing Internet searches.

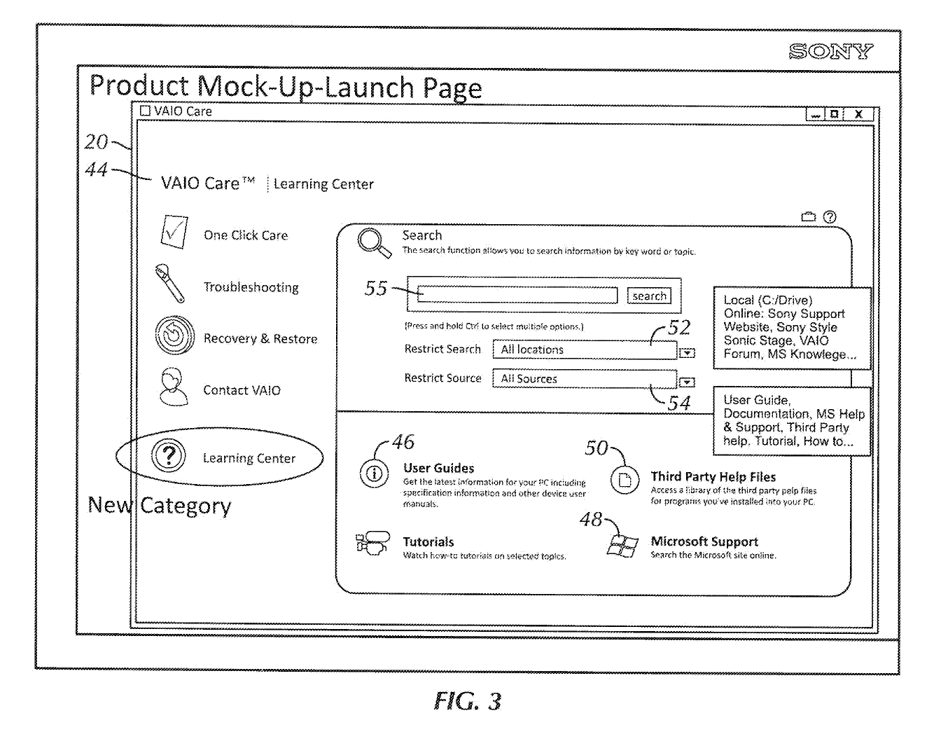

Overall logic according to present principles may be seen in reference to FIG. 2. Commencing at block 36, a search is conducted by, e.g., the manufacturer of the computer 10 for help resources pertaining to the particular model of the computer 10 that are available from Internet sources, e.g., from any of the servers shown in FIG. 1. At block 38 help content along with its Internet location is identified from the provider of the O.S. of the computer 10 as is help information from third party providers of applications that may be resident on the computer 10 at, e.g., point of sale. If desired, the various help documentation located in the preceding steps may be converted to extensible markup language (XML) at block 40. After sale of the computer 10 to a user, at block 42 the user interfaces (UIs) discussed below may be presented on the display 20 to allow a user to conveniently select from multiple help information sources.

Indeed and turning now to FIG. 3, a UI 44 may be presented on the display 20 of the computer at, e.g., power-on. As shown, the example UI 44 includes a column of technical help selections, one of which is “Learning Center”. When “Learning Center” is selected, the remaining elements of the UI 44 shown in FIG. 3 may be presented.

In the example shown, the UI 44 includes a first selector element 46 selectable by a user by means of, e.g., the input device 18 to select help information from a manufacturer of the computer. In some embodiments help information from the manufacturer may be preloaded onto the computer storage medium 14 of the computer while other help information from the manufacturer is downloaded from the Internet. Also, a second selector element 48 may be selected to select help from an operating system (O.S.) provider associated with an O.S. executed by the processor. Further, help from third party application providers may be obtained by selecting a third selector element 50 on the UI 44. A “tutorials” selector element may also be provided as shown to invoke one or more tutorial programs executed by the processor 12 and presented on the display 20. Selection of one of the selector elements 46-50 causes help documentation from the respective source to be accessed and presented on the display 20.

If desired, the UI 44 can further include a list 52 of help sources from which a user may select a source to be searched for a particular help item desired by the user. The list, which can be invoked by a drop-down menu as shown, may include a hard disk drive (HDD) of the computer, a website associated with the manufacturer of the computer, an online help forum associated with the computer type, and an Internet site associated with the provider of the O.S. The example UI 44 can further include a drop-down list 54 of help documentation type which includes a user guide, O.S. help guide, third party help guide, and tutorials.

A search field 55 may be provided into which a user may enter one or more help search terms. The scope of the search may be restricted to all or fewer than all of the locations and sources on the lists 52, 54 as shown.

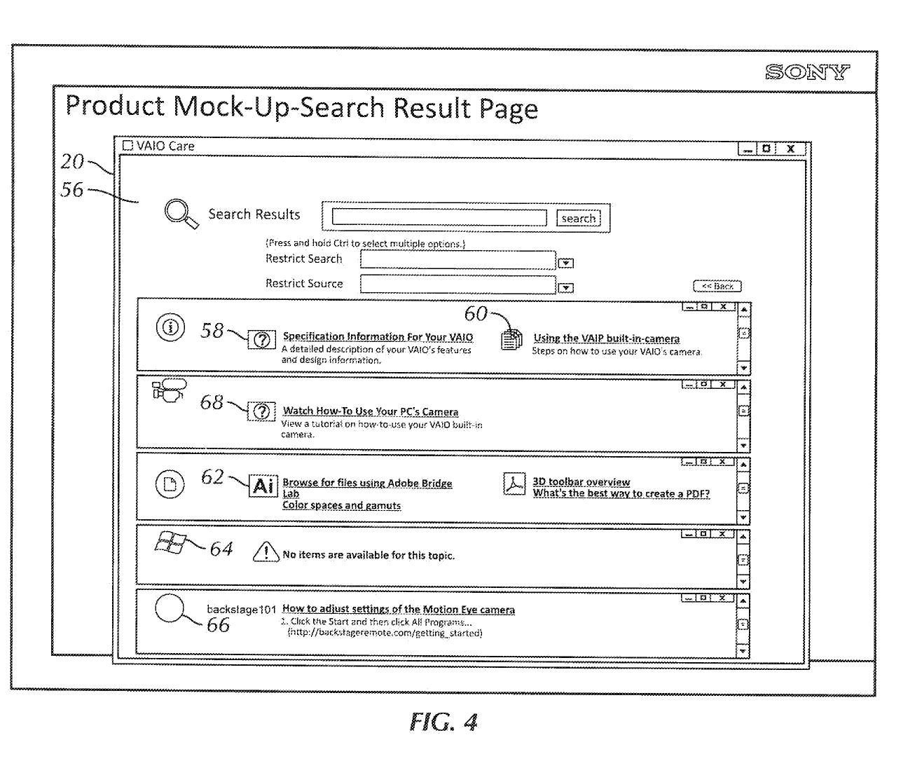

FIG. 4 shows that a second UI 56 may be presented on the display responsive to the user request for help (search) entered by means of the first UI 44. The second UI 56 contains hyperlinks to plural specific help documentation sources as shown which contain information relevant to the user's search terms input into the field 55 of FIG. 3. Selecting a hyperlink causes the associated help document to be retrieved from, e.g., the Internet and presented on the display 20.

The hyperlinks in the second UI can include, e.g., a hyperlink 58 to specification documentation for the computer, a hyperlink 60 to information related to a peripheral component associated with the computer, and a hyperlink 62 to information related to a software application that is executable by the processor 12. Multiple such hyperlinks 62 for various third party applications may be provided.

Additionally, a hyperlink 64 pointing to information provided by the O.S. provider may be presented as shown. A hyperlink 66 may be provided that links the user to a help resource server (referred to in FIG. 4 as “backstage”) provided by the manufacturer of the computer 10. Moreover, a hyperlink 68 can be provided that links the user to an audio video tutorial program containing information pertinent to the user's input search terms.

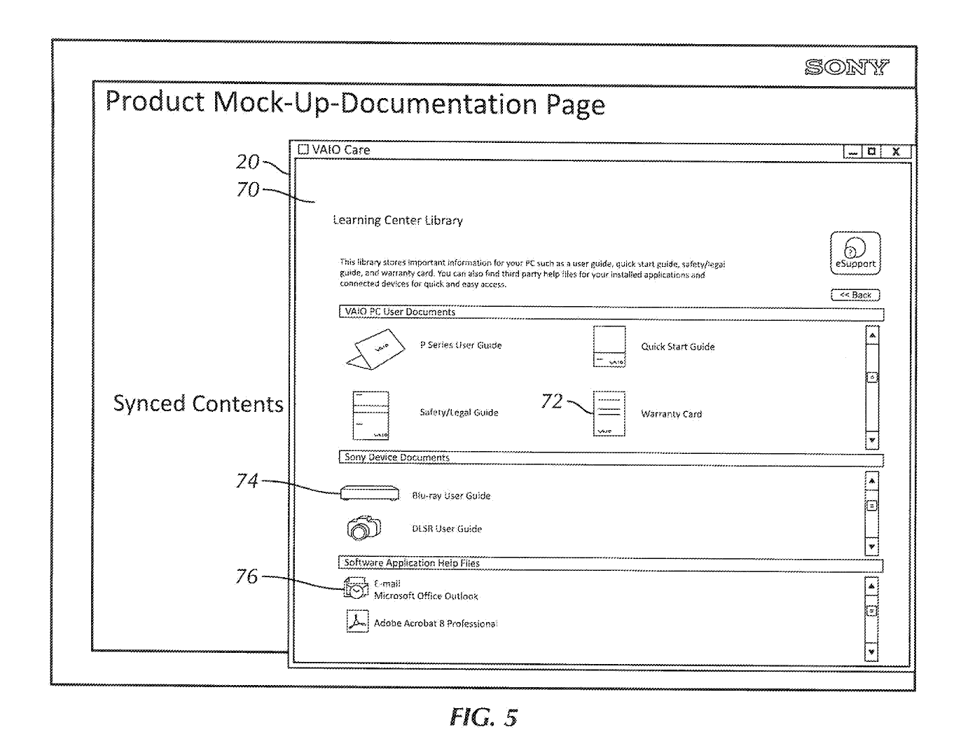

FIG. 5 shows that if desired, a third UI 70 may be presented on the display 20 that can include hyperlinks 72 to electronic user guides related to the model of the computer regardless of any particular search query for help. Hyperlinks 74 may also be provided on the UI 70 to information related to consumer electronic (CE) devices made by the manufacturer of the computer. Also, hyperlinks 76 can link the user to information related to third party software loaded onto the computer. The contents pointed to by the various hyperlinks 72-76 are synchronized in that they may all be provided in the same format, e.g., XML.

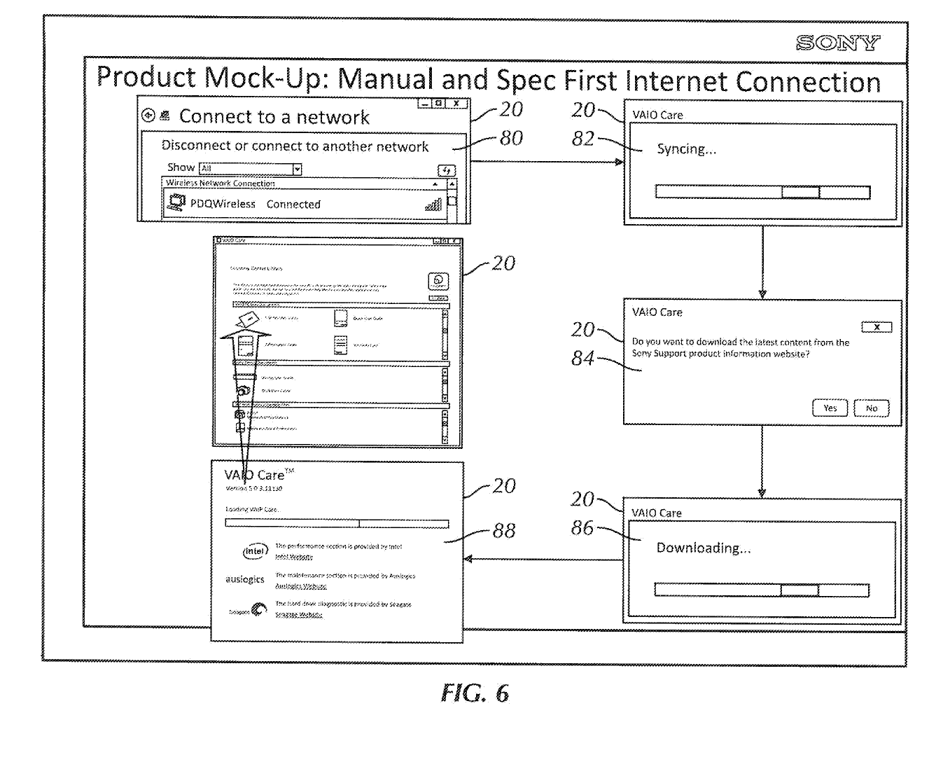

FIG. 6 shows a series of screen shots that can occur upon connection to the Internet. The screen shot 80 appears as the computer establishes a wireless connection to the Internet, and immediately thereafter the screen shot 82 appears informing the user that various help resources are being identified on the Internet and are being synchronized. A screen shot 84 enables a user to download the help content which, if the user selects “yes”, causes the download screen shot 86 to appear. A list of the downloaded help content is presented in the screen shot 88 along with hyperlinks to the help documentation that may be selected by a user to retrieve the associated help documentation from the Internet.

While the particular PRODUCT INFORMATION MANAGEMENT AND AUTOMATION is herein shown and described in detail, it is to be understood that the subject matter which is encompassed by the present invention is limited only by the claims.

What is claimed is:

1. Computer comprising:
processor; and
display controlled by the processor to present a first user interface (UI) on the display, the first UI including a first selector element selectable by a user by means of an input device communicating with the processor to select help information from a manufacturer of the computer, from an operating system (O.S.) provider associated with an O.S. executed by the processor by selecting a second selector element on the UI, and from third party application providers by selecting a third selector element on the UI.

2. The computer of claim 1, wherein at least some help information from the manufacturer is preloaded onto a computer storage medium of the computer and at least some help information from the manufacturer is downloaded from the Internet.

3. The computer of claim 1, wherein the UI further comprises a list of help sources from which a user may select a source, the list including a hard disk drive (HDD) of the computer, a website associated with the manufacturer of the computer, an online help forum associated with the computer type, and an Internet site associated with the provider of the O.S.

4. The computer of claim 1, wherein the UI further comprises a list of help documentation type, the list of help documentation type including a user guide, O.S. help guide, third party help guide, and tutorials.

5. The computer of claim 1, wherein a processor causes a second UI to be presented on the display responsive to a user request for help entered by means of the first UI, the second UI containing hyperlinks to plural help sources.

6. The computer of claim 5, wherein the help sources having hyperlinks in the second UI include specification documentation for the computer, information related to a peripheral component associated with the computer, information related to at least one software application executable by the processor, and information provided by the O.S. provider.

7. The computer of claim 1, wherein the processor presents a third UI on the display including hyperlinks to electronic user guides related to the model of the computer, hyperlinks to information related to devices made by the manufacturer of the computer, and hyperlinks to information related to third party software loaded onto the computer.

8. Method comprising:
providing a series of user interfaces (UIs) on a computer display;
by means of the UIs, allowing a user to select sources of help for various aspects of the computer, the sources including the manufacturer of the computer, a provider of an operating system (O.S.) executed by the computer, and third party providers of applications executable by the computer.

9. The method of claim 8, comprising presenting a first user UI on the display, the first UI including a selector element selectable by a user by means of an input device to select help information from a manufacturer of the computer by selecting a second selector element on the UI, from an operating system (O.S.) provider associated with an O.S. executed by the processor by selecting a third selector element on the UI, and from third party application providers by selecting a fourth selector element on the UI.

10. The method of claim 8, wherein at least some help information from the manufacturer is preloaded onto a computer storage medium of the computer and at least some help information from the manufacturer is downloaded from the Internet.

11. The method of claim 9, wherein the first UI further comprises a list of help sources from which a user may select a source, the list including a hard disk drive (HDD) of the computer, a website associated with the manufacturer of the computer, an online help forum associated with the computer type, and an Internet site associated with the provider of the O.S.

12. The method of claim 9, wherein the first UI further comprises a list of help documentation type, the list of help documentation type including a user guide, O.S. help guide, third party help guide, and tutorials.

13. The method of claim 9, comprising presenting a second UI on the display responsive to a user request for help entered by means of the first UI, the second UI containing hyperlinks to plural help sources.

14. The method of claim 13, wherein the help sources having hyperlinks in the second UI include specification documentation for the computer, information related to a peripheral component associated with the computer, information related to at least one software application executable by the processor, and information provider by the O.S. provider.

15. The method of claim 13, comprising presenting a third UI on the display including hyperlinks to electronic-user guides related to the model of the computer, hyperlinks to information related to devices made by the manufacturer of the computer, and hyperlinks to information related to third party software loaded onto the computer.

16. Apparatus comprising:
processor; and
display controlled by the processor to present a first user interface (UI) to search for multiple technical help sources by source type and a second UI providing hyperlinks to specific technical help sources conforming to a search signal entered by means of the first UI.

17. The apparatus of claim 16, wherein the first UI includes a selector element selectable by a user by means of an input device communicating with the processor to select help information from a manufacturer of the computer by selecting a second selector element on the UI, from an operating system (O.S.) provider associated with an O.S. executed by the processor by selecting a third selector element on the UI, and from third party application providers by selecting a fourth selector element on the UI.

18. The apparatus of claim 16, wherein the first UI further comprises a list of help sources from which a user may select a source, the list including a hard disk drive (HDD) of the computer, a website associated with the manufacturer of the computer, an online help forum associated with the computer type, and an Internet site associated with the provider of the O.S.

19. The apparatus of claim 16, wherein the first UI further comprises a list of help documentation type, the list of help documentation type including a user guide, O.S. help guide, third party help guide, and tutorials.

20. The apparatus of claim 18, wherein the hyperlinks in the second UI include respective links to specification documentation for the computer, information related to a peripheral component associated with the computer, information related to at least one software application executable by the processor, and information provider by the O.S. provider.
